(19) United States
(12) Patent Application Publication
(10) Pub. No.: US 2022/0175126 A1
(43) Pub. Date: Jun. 9, 2022

(54) BIODEGRADABLE TOOTH BRUSH REPLACEMENT HEAD

(71) Applicant: TDS MANAGEMENT ZIMBA, LLC, BOCA RATON, FL (US)

(72) Inventor: CHRISTINA RAMIREZ, BOCA RATON, FL (US)

(21) Appl. No.: 17/542,058

(22) Filed: Dec. 3, 2021

Related U.S. Application Data
(60) Provisional application No. 63/121,458, filed on Dec. 4, 2020.

(51) Int. Cl. A46B 5/00; A61C 17/22; A46B 9/04; A61C 17/34; A46D 1/00; A46B 7/04

(52) U.S. Cl. CPC A46B 5/0095; A61C 17/22; A46B 7/04; A61C 17/3481; A46D 1/0207; A46B 9/04

(57) ABSTRACT

A biodegradable replaceable toothbrush head preferably for an electric toothbrush. The replacement head can be configured to be removably connected and operated by one or more conventional electric power/drive units. Various biodegradable materials can be used alone or in combination for constructing the replacement head and in certain embodiments the biodegradable replacement can be constructed from solely or primarily corn starch or bamboo. In another non-limiting embodiment, the biodegradable replacement head can be construction from about 60-80% polylactic acid, and about 20-40% talcum.

### RELATED APPLICATIONS

This application claims the benefit of and priority to U.S. Application Ser. No. 63/121,458, filed on Dec. 4, 2020, which application is incorporated by reference in its entirety as if fully set forth herein and for all intended purposes.

### FIELD OF THE DISCLOSURE

The disclosure relates generally to the field of toothbrushes and more particularly to replaceable toothbrush heads for use with electric toothbrushes.

### BACKGROUND

Toothbrushes are well known for use in cleaning teeth and typical come in non-electric and electric handheld variations. With respect to electric handheld toothbrushes, a plastic toothbrush head is removably attached to an electric unit that activates the toothbrush head to vibrate to simulate the motion of the human hand brushing the teeth. After a period of time and/or once the bristles of the toothbrush or toothbrush head is worn, the toothbrush or toothbrush head is de-attached from the electric unit and typically thrown away or otherwise discarded. As the toothbrush head is composed of or constructed from plastic, this creates a problem for the environment because the discarded toothbrushes/toothbrush heads accumulate and may not degrade. Thus, the current use of plastics to make toothbrushes and toothbrush heads can harm the environment because the discarded toothbrushes and toothbrush heads cause landfills to fill up and contribute to the product's carbon footprint. This can also add to the cost to the disposal of the plastic by using fossil fuels to dispose of the plastic. The novel replaceable toothbrush heads described below are directed to overcoming the problems and limitations associated with plastic replacement toothbrush heads discussed above.

### SUMMARY OF THE DISCLOSURE

Generally, disclosed are one or more embodiments for a biodegradable replacement head for a toothbrush, such as, without limitation, for an electric toothbrush. It is also within the scope of the disclosure that other embodiments include a biodegradable toothbrush (i.e., handle and head) and/or that the replacement head is removably connectable to a non-electric toothbrush handle. In some embodiments, the replacement heads are used with and removably connected to conventional electric toothbrush units and the operations and general use of a conventional electric toothbrush is considered well known and incorporated by reference. In some embodiments, the instant disclosure can be, alternatively or additionally, for a removable/replacement head for a non-electric handheld manual toothbrush.

The disclosure also includes a biodegradable toothbrush embodiment for brushing teeth having a handle, a toothbrush head, an elongated neck for connecting the handle and the toothbrush head.

In embodiments, the toothbrush or the replaceable toothbrush head can be made of a combination of polylactic acid and talcum. For example, the toothbrush head can be composed of approximately 50-90% polylactic acid and 10-50% talcum. In some embodiments, the toothbrush head can be composed of about 60-80% polylactic acid, and about 20-40% talcum. In some embodiments, the toothbrush head can be composed of up of about 65-75% polylactic acid and about 25-35% talcum. In some embodiments, the toothbrush head can be composed of 70% polylactic acid and 30% talcum. Other ranges can be used and/or other biodegradable materials can be used for the toothbrush and the replaceable toothbrush head and are also considered within the scope of the disclosure. In some embodiments, the toothbrush or replaceable toothbrush head can be made or constructed from solely or primarily corn starch.

Accordingly, through the use of one or more biodegrade materials, such as, without limitation, corn starch and/or bamboo, for constructing the replaceable toothbrush head or toothbrush, the problems associated with using plastic replacement toothbrush heads and toothbrushes can be reduced, if not obviated. Accordingly, the disclosed novel replacement toothbrush heads may lessen the carbon footprint, the overflow of landfills, and create an effective replaceable toothbrush head that is environmentally friendly.

In some embodiments, the techniques described herein relate to an electric toothbrush system including, a brush head including a neck and a head, the head including a plurality of bristles, wherein the brush head is composed of at least one biodegradable material; and an electric drive unit configured to be connected to the brush head and configured to actuate the brush head.

In some embodiments, the techniques described herein relate to an electric toothbrush system, wherein the at least one biodegradable material is corn starch, dextrose, bamboo or a combination of about 60-80% polylactic acid and about 20-40% talcum.

In some embodiments, the techniques described herein relate to an electric toothbrush system wherein the polylactic acid is derived from corn starch or dextrose.

In some embodiments, the techniques described herein relate to an electric toothbrush system wherein the at least one biodegradable material is bamboo.

In some embodiments, the techniques described herein relate to an electric toothbrush system further including a ring disposed within an internal passageway of the neck of the brush head at an opening for connecting the brush head to the electric drive unit.

In some embodiments, the techniques described herein relate to an electric toothbrush system wherein the actuation is transmission of vibrational forces from the electric drive unit to the brush head.

In some embodiments, the techniques described herein relate to an electric toothbrush system wherein the head of the brush head is circular or oval in shape.

In some embodiments, the techniques described herein relate to an electric toothbrush system wherein the head and the neck are monolithically formed or constructed integral together to form a one-piece member.

In some embodiments, the techniques described herein relate to an electric toothbrush system wherein the plurality of bristles are SOFT BPA free durable nylon bristles or bristles manufactured from castor bean oil.

In some embodiments, the techniques described herein relate to an electric toothbrush system, wherein the plurality of bristles extend from a bristle plate and the bristle plate is detachably disposed on the head of the brush head.

In some embodiments, the techniques described herein relate to a biodegradable replacement head for an electric toothbrush, including: a body member having a first end and a second end and defining an internal passageway, the body member having an opening at the first end for accessing the internal passageway, the body member adapted for removable connection to an electric power/drive unit of an electric toothbrush through receipt of a portion of the electric power/drive unit within the internal passageway, the body member constructed from one or more biodegradable materials; and a plurality of bristles located near the second end of the body member.

In some embodiments, the techniques described herein relate to a biodegradable replacement head wherein the one or more biodegradable materials is corn starch or dextrose.

In some embodiments, the techniques described herein relate to a biodegradable replacement head wherein the one or more biodegradable materials is bamboo.

In some embodiments, the techniques described herein relate to a biodegradable replacement head wherein the one or more biodegradable materials including about 60-80% polylactic acid; and about 20-40% talcum.

In some embodiments, the techniques described herein relate to a biodegradable replacement head further including a ring disposed within the internal passageway at the opening of the first end for aiding in connection of the body member to the electric power/drive unit.

In some embodiments, the techniques described herein relate to a biodegradable replacement head further including a bristle connection portion disposed at the second end of the body member.

In some embodiments, the techniques described herein relate to a biodegradable replacement head wherein the bristle connection portion is circular or oval in shape.

In some embodiments, the techniques described herein relate to a biodegradable replacement head wherein the bristle connection portion and the body member monolithically formed or constructed integral together to form a one-piece member.

In some embodiments, the techniques described herein relate to a biodegradable replacement head wherein the polylactic acid is derived from corn starch.

In some embodiments, the techniques described herein relate to a biodegradable replacement head wherein the plurality of bristles are SOFT BPA free durable nylon bristles or the plurality of bristles are composed of castor bean oil.

In some embodiments, the techniques described herein relate to a biodegradable replacement head further including a base member disposed at the first end of the body member and having an internal passageway which is in communication with the internal passageway of the body member.

In some embodiments, the techniques described herein relate to a biodegradable replacement head for an electric toothbrush, including: a body member having a first end and a second end and defining an internal passageway, the body member having an opening at the first end for accessing the internal passageway, the body member adapted for removable connection to an electric power/drive unit of an electric toothbrush through receipt of a portion of the electric power/drive unit within the internal passageway, the body member constructed from one or more biodegradable materials; a bristle plate detachably disposed at the second end of the body member; and plurality of bristles connected to the bristle plate and extending outward therefrom.

In some embodiments, the techniques described herein relate to a biodegradable replacement head wherein the one or more biodegradable materials is corn starch, bamboo or a combination of about 60-80% polylactic acid and about 20-40% talcum.

In some embodiments, the techniques described herein relate to a biodegradable replacement head wherein the second end having a circular or oval shape.

In some embodiments, the techniques described herein relate to a biodegradable replacement head wherein the second end includes a cavity and the bristle plate is at least partially detachably disposed within the cavity.

In some embodiments, the techniques described herein relate to a biodegradable replacement head wherein the plurality of bristles can be SOFT BPA free durable nylon bristles.

In some embodiments, the techniques described herein relate to a biodegradable replacement head further including a base member disposed at the first end of the body member and having an internal passageway which is in communication with the internal passageway of the body member.

In some embodiments, the techniques described herein relate to a biodegradable replacement head for an electric toothbrush, including: a body member having a first end and a second end and defining an internal passageway, the body member having an opening at the first end for accessing the internal passageway, the body member adapted for removable connection to an electric power/drive unit of an electric toothbrush through receipt of a portion of the electric power/drive unit within the internal passageway, the body member constructed from one or more biodegradable materials; a bristle connection portion disposed at the second end of the body member, the bristle connection portion being rounded in shape; plurality of bristles connected to the bristle connection portion and extending outward therefrom; and a base member disposed at the first end of the body member and having an internal passageway which is in communication with the internal passageway of the body member; wherein the bristle connection portion and the body member monolithically formed or constructed integral together to form a one-piece member.

In some embodiments, the techniques described herein relate to a biodegradable replacement head wherein the one or more biodegradable materials is corn starch, bamboo or a combination of about 70% polylactic acid and about 30% talcum.

In some embodiments, the techniques described herein relate to a biodegradable replacement head wherein the plurality of bristles can be SOFT BPA free durable nylon bristles.

In some embodiments, the techniques described herein relate to a method of constructing a toothbrush, the method including, removing a brush head from a drive unit; and attaching a biodegradable brush head to the drive unit; wherein the biodegradable brush head is composed of a biodegradable material that is capable of being composted.

### BRIEF DESCRIPTION OF THE DRAWINGS

FIG. 1 is a perspective exploded view showing a first non-limiting biodegradable replacement head embodiment for removable attachment to a first non-limiting electric toothbrush unit in accordance with the present disclosure;

FIG. 2 is a perspective exploded view showing a second non-limiting biodegradable replacement head embodiment for removable attachment to a second non-limiting electric toothbrush unit in accordance with the present disclosure;

FIG. 3 is a perspective exploded view showing a third non-limiting biodegradable replacement head embodiment for removable attachment to the first non-limiting electric toothbrush unit in accordance with the present disclosure;

FIG. 4 is a perspective exploded view showing a fourth non-limiting biodegradable replacement head embodiment for removable attachment to the second non-limiting electric toothbrush unit in accordance with the present disclosure;

FIG. 5A is a bottom view of a first biodegradable replacement head;

FIG. 5B is a bottom view of a second biodegradable replacement head; and

FIGS. 6A-6E are various views of a biodegradable replacement head according to some embodiments.

### DETAILED DESCRIPTION

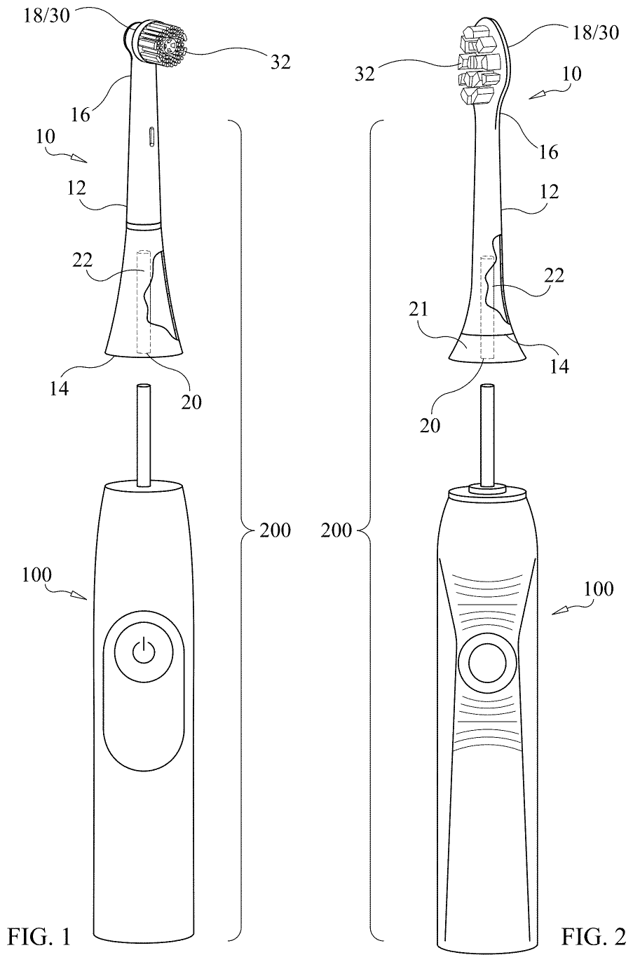

In general, as seen in FIGS. 1-4, biodegradable replaceable toothbrush heads are shown and designated as replacement head 10. Preferably, the replacement head 10 is removably connected to an electric power unit 100, with the electric power unit and attached replacement head constituting an electronic toothbrush 200. One or more standard or typical parts and components of electric power units and toothbrush replacement heads that are used for operation and/or attachment of the toothbrush replacement head that are not described herein are considered to be generally known in the industry and incorporated by reference and considered to also be included with the scope of the disclosure and considered available for use with the toothbrush replacement heads described and shown herein.

Furthermore, in the following exemplary description numerous specific details are set forth in order to provide a more thorough understanding of the described and disclosed embodiments. It will be apparent, however, to an artisan of ordinary skill that the disclosed embodiments may be practiced without incorporating all aspects of the specific details described herein and, as referenced above, may also include parts and/or components commonly found with toothbrush replacement heads that are not specifically discussed herein.

Additionally, although steps or processes may be set forth in an exemplary order to provide an understanding of one or more replacement heads and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the disclosure. In other instances, specific features, parts, components, quantities, or measurements well known to those of ordinary skill in the art have not been described in detail so as not to obscure the novelty of the embodiments disclosed herein. It should be noted that although several embodiments are set forth herein, the claims, and the full scope of any equivalents, are what define the metes and bounds of the disclosure.

For a better understanding of the disclosed embodiments, their operating advantages, and the specified object attained by their uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second,” and the like, herein do not denote any order, quantity or importance, but rather are used to distinguish one element from another, and the terms “a” and “an” herein do not denote a limitation of quantity, but rather denote the presence of at least one of the referenced item.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” “attached to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” “approximately,” and similar terms are used as terms of approximation and not as terms of degree, and are intended to account for the inherent deviations in measured or calculated values that would be recognized by those of ordinary skill in the art. Further, the use of “may” when describing one of the disclosed embodiments refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to as anon-limiting example or illustration.

Unless otherwise defined, all terms (including technical and scientific terms) used herein have the same meaning as commonly understood by one of ordinary skill in the art to which the instant disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

One or more embodiments are disclosed and described below. As described previously, current use of plastics to make toothbrush heads contributes to harm to the environment because they cause landfills to fill up and contribute to the product's carbon footprint. The use of plastics to manufacture the toothbrush heads adds to the cost to the disposal of the plastic by using fossil fuels to dispose of the plastic. The disclosed embodiments describe novel biodegradable toothbrush replacement heads that may biodegrade or decompose.

As seen in the embodiments shown in FIGS. 1-4, a replacement head, or replacement brush head, 10 can generally include a neck 12 for attachment to an electric power/drive unit 100. The neck 12 can be shaped in various configurations, and in the illustrated embodiments seen in FIGS. 1 through 4, the neck 12 can be of a generally tubular hollow body that extends along a longitudinal axis. The inner and/or outer diameter of neck 12 can be varied such that the neck 12 is flared, or the neck 12 can be generally consistent. In general, the neck 12 can extend from a first end 14 where the head 10 is removably connected to electric power/drive unit 100 to a second end 16 of the neck 12 that terminates at the brush/bristles areal/member 18 of the head 10. In some embodiments, where the diameter is varied, the diameter of the neck 12 can be larger at the first end 14 and gradually reduce in size such that the diameter at the second end 16 is smaller than the diameter at first end 14.

The neck can additionally include an opening 20 to provide access to an internal passageway 22 within the neck 12, at the first end 14. The bristle area 18 can include a body portion 30 to which the bristles 32 are connected to and/or extend outward from. The body portion 30 and neck 12 can be monolithically formed, molded together and/or constructed integrally as a one-piece member. Alternatively, the body portion 30 and neck 12 can be separate pieces that are connected together, and all configurations are considered within the scope of the disclosure.

In some embodiments, the biodegradable material(s) used for constructing the replacement head 10 can have a hardness suited to maintain form during use while providing a degree of flexibility for user comfort and an effective preferred friction fit with electric power unit 100. In some embodiments, the hardness of the chosen biodegradable material can be between about 30 and 120 Shore A durometer. In some embodiments, the hardness of the biodegradable material can be between 50 and 100 Shore A durometer.

The interior of neck 12 may include structure/components for receiving, mounting and retaining head 10 to electric power/drive unit 100 and for guiding and operating brush head/bristles, during use of the toothbrush. The body of power/drive unit 100 can includes a handle/gripping area for the using the disclosed novel toothbrushes. The head 10 can be mounted to the power/drive, unit 100 such that brush head 10 is prevented from unwanted rotation with respect to power/drive unit 100. For example, the neck 12 can include structures that can abut, fit in, receive or otherwise interact with corresponding structure on the power/drive unit 100 to restrict relative rotation of the brush head 10 with respect to the power/drive unit 100. Alternatively, any mounting configuration can be used for safely removably securing brush head 10 to electrical power/drive, unit 100 during use of the disclosed novel electric toothbrush.

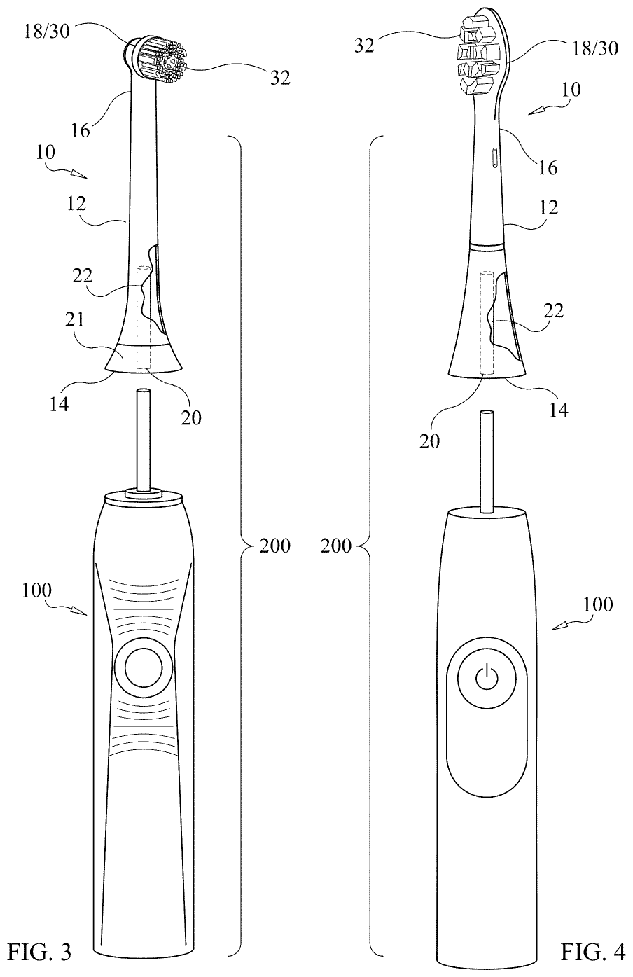

In some embodiments, the shape of the bristle connection area 18 (i.e., body portion 30) can be preferably oval shaped, as seen in FIGS. 2 and 4. In some embodiments, the bristle connection area 18/body portion 30 can have a generally round shape, as shown in FIGS. 1 and 3. Alternatively, square, elliptical and other shapes, can also be used and are also considered within the scope of the disclosure. Specific to a round or oval head (bristle connection area 18) shape, minor injury or pain from use of the replacement head may also be reduced, or eliminated, as the head may have less, to no, sharp corners, as compared to other shapes. The round head shape for the bristle connection area 18 may also provide the user with a better ability to reach their back teeth as compared to other shapes.

The bristles 32 can be secured to or at connection area 18 can be all of the same length, thickness and/or stiffness or the bristles can be of varying lengths (i.e., more than one length), thickness (i.e., more than one thickness) and/or stiffness (i.e., more than one stiffness). In some embodiments, the bristles can be manufactured from castor bean oil so that they are additionally biodegradable. In some embodiments, the bristles 32 may be received within the connection area 18 in such a fashion that they can be easily removed before disposing the replacement/removable brush head 10, while the bristles 32 are retained in the connection area 18 during use in a user's mouth. In some embodiments, the bristles 32 can removably attached to the brush head. In some embodiments, the bristles may be simply pulled out from the brush head 1000.

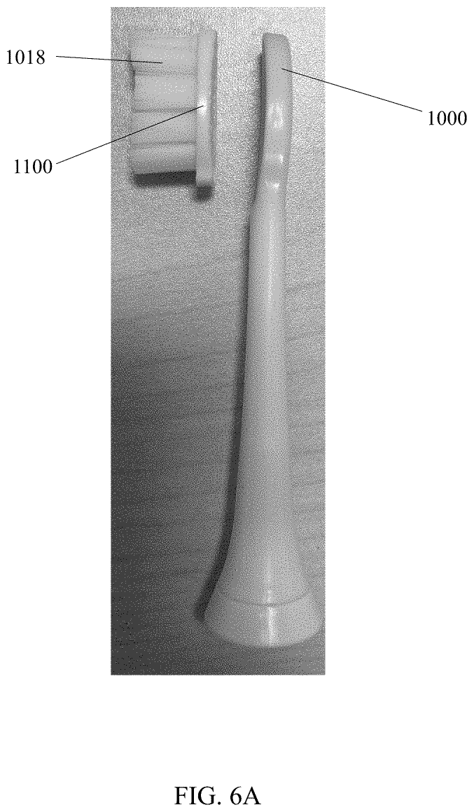

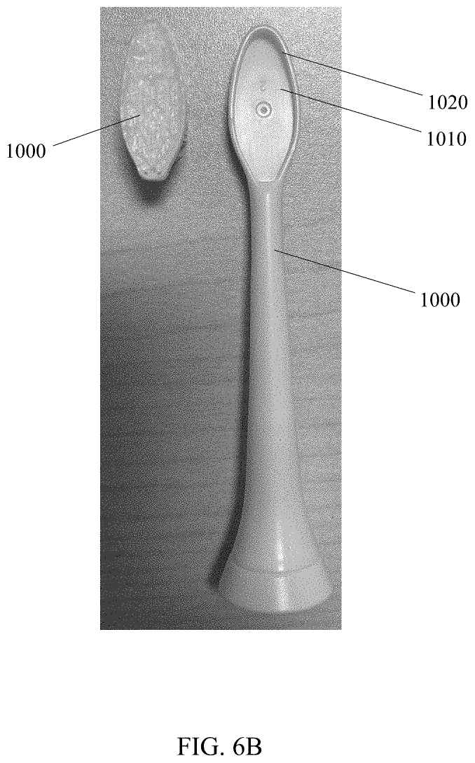

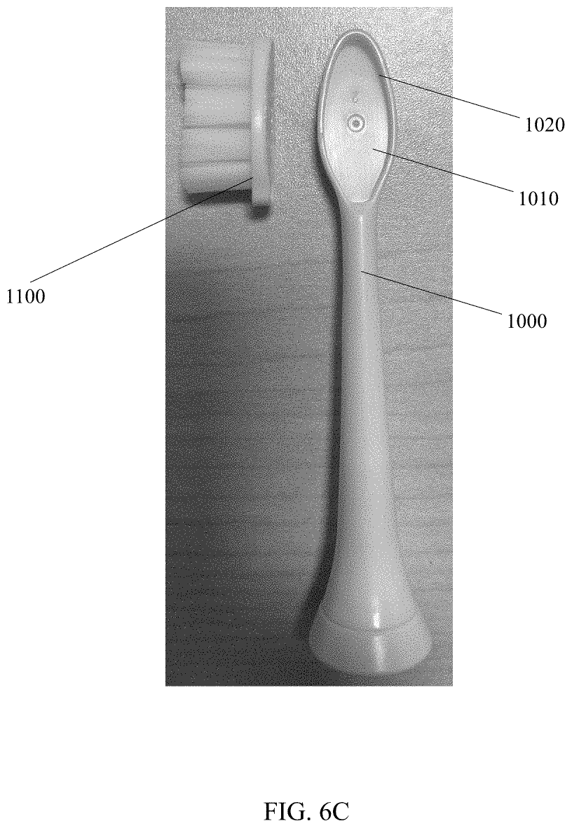

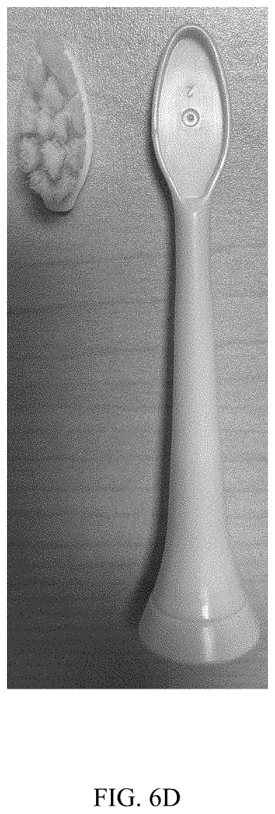

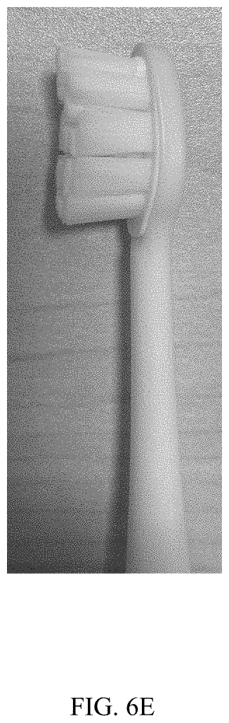

In some embodiments, as seen in FIGS. 6A-6E, a brush head 1000 can include a removable bristle plate 1100 which can securely retain a plurality of bristles 1118. In the illustrated embodiment the brush head 1000 includes a recess 1010 that is shaped to substantially the same shape and thickness of a corresponding bristle plate 1100. The bristle plate 1100 can be retained in the recess 1010 by means of a friction fit, a press fit, my means of a frangible connection, or other mechanical or chemical retaining mechanism. For example, the recess 1010 can include a lip 1020 on an upper face of the brush head 1000 that can retain the bristle plate 1100 in the recess 1010. In some embodiments, the bristle plate 1100 can include a recess to receive a projection disposed on a face of the brush head 1000. Regardless of how the bristle plate 1100 is retained with respect to the brush head 1000, the user can remove the bristle plate 1100 from the brush head 1000 when the brush head is being replaced so that the brush head 1000 can be composted or biodegraded and the bristle head can be properly disposed of separately.

Though the above and below biodegradable features/materials are primarily described in connection with a replacement/removable toothbrush head, it is also within the scope of this disclosure that such features/materials may also be applied to conventional non-mechanical toothbrushes and variations thereof.

The shape of electric power/drive unit 100 is not limited to any particular shape and all practical shapes are considered within the scope of the disclosure.

The elongated neck 12 may be a simple shaft, or it may be more complex with different textures, shapes, and angles and all configurations are considered within the scope of the disclosure. Additionally, the brush head 10 can include a rod that can extend within at least a portion of the neck 12 and is slid into/inside brush head 10 body. During use of the electronic toothbrush with brush head 10 attached to electric power/drive unit 100, vibrations, created by the vibrating movement of unit 100, can be sent up/transferred to the inserted rod which can then vibrate at least a portion of brush head 10 including the bristles.

Preferably, no motor or electronics are disposed within brush head 10 itself. The lack of motors or electronics in the brush head 10 of the instant disclosure allows for the brush head 10 to be more easily composted or recycled. This is due to the complex composition of most mechanical or electrical assemblies which prevent devices from being easily disposed of without harm to the environment. It is contemplated that some electrical or mechanical assemblies could be manufactured from the materials described herein such that the resulting brush head would be easily compostable or recycled.

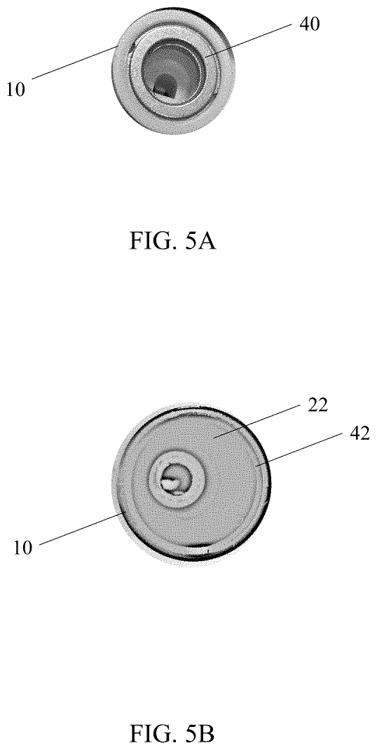

In some embodiments, as seen in FIG. 5A, the toothbrush head 10 can have a metal insert 40, disposed inside of the brush head 10, to attach to an electric toothbrush head/tip/protrusion. In some embodiments, the insert can be a metal ring 40 disposed on a lower surface of the toothbrush head 10. Alternatively, the insert can also be a plastic ring, a biodegradable ring, or a ring shape of another material. In some embodiments, as shown in FIG. 5B, the ring 42 can be integrally formed with the toothbrush head 10 and be a ring of material on the radially inward facing surface of the internal passageway 22. In some embodiments, the ring 40 can be copper, steel, stainless steel or other metal or non-metal ring, can be disposed within brush head 10/neck 12. The metal ring or the integral structure 42 can function to hold, or otherwise retain, the brush head 10 in place with respect to unit 100. The metal ring 40 or integral ring 42 can also be provided for securing the brush neck to a base 21, where the parts are separate and not formed as one piece, as shown in FIGS. 2 and 3. The ring can also be providing in base 21 for aiding and/or assisting in connection of base 21 to electric power/drive unit 100.

In some embodiments, the removable/replaceable toothbrush head can be constructed solely or primarily from corn starch or bamboo. In some embodiments, the brush head can be constructed from a combination of polylactic acid and talcum. For example, the toothbrush head can be composed of approximately 50-90% polylactic acid and 10-50% talcum. In some embodiments, the toothbrush head can be composed of up of about 60-80% polylactic acid and about 20-40% talcum. In some embodiments, the toothbrush head can be composed of up of about 65-75% polylactic acid and about 25-35% talcum. In still other embodiments, the toothbrush head can be composed of up of about 68-72% polylactic acid and about 28-32% talcum. In some embodiments, the toothbrush head can be composed of 70% polylactic acid and 30% talcum.

Alternatively, other materials can be used for manufacturing the toothbrush head 10 can include Polylactic acid (PLA) that can be a transparent plastic produced from corn or dextrose. This material may be similar to conventional petrochemical-based mass plastics like PS; but provides the advantage of degrading to nontoxic products. Additionally, polylactic acid and polylactic acid blends may come in the form of granulates with various properties, and may be used for the production of films, fibers, plastic containers, cups, and bottles and can also be within the scope of disclosure of materials that can be used for constructing brush head 10.

In one exemplary method of manufacturing the toothbrush head, PLA may be made from the sugars in corn starch. In order to transform corn into plastic, corn kernels may be immersed in sulfur dioxide and hot water, where its components break down into starch, protein, and fiber. The kernels may then be ground, and the corn oil may be separated from the starch. The starch may be composed of long chains of carbon molecules, similar to the carbon chains in plastic from fossil fuels. Citric acids may be mixed in to form a long-chain polymer, which may make it ideal for molding into the toothbrush head body member (i.e., neck 12 and bristle connection area 18). Thus, the preferred PLA can look and behave like polyethylene (used in plastic films, packing and bottles), polystyrene (Styrofoam and plastic cutlery) or polypropylene (packaging, auto parts, textiles)—which makes it ideal for molding and yet still biodegradable.

Use of a biodegradable plastic material(s), including, without limitation, bioplastics, as the materials for brush head 10, can provided the following non-limiting advantages and benefits (1) reduced use of fossil fuel resources, (2) smaller carbon footprint, and/or (3) faster decomposition. Accordingly, brush head 10 can be preferably biodegradable and carbon-neutral. Additionally, the materials use can also be considerable edible materials. The bioplastic material(s) that can be used for brush head 10 can also be less toxic and preferably not contain bisphenol A (BPA), which is known to be a hormone disruptor often found in traditional plastics.

Other alternatives for polylactic acid can include starch, cellulose, polysaccharide, polycaprolactam, polyglycolic acid, polyorthoester, and/or polypeptide. With respect to useable polylactic acid for constructing the toothbrush head body member, it may also include racemic PLLA (Poly-L-lactic Acid), regular PLLA (Poly-L-lactic Acid), PDLA (Poly-D-lactic Acid), and PDLLA (Poly-DL-lactic Acid).

The toothbrush head body member may also be made up of about 20-40% talcum. Moreover, other substitutes for talcum, that can also be used and considered within the disclosure, can include inorganic nucleators, wollastonite, kaolin, lime carbonate, mica, or silicon-dioxide.

As mentioned above, the disclosed novel replacement toothbrush head 10 acts and performs in the same way as any conventional replaceable electric toothbrush head, including, without limitation, snapping onto the electric power/drive unit 100 of the electric toothbrush. Once the old head is removed from its connection to electric power/drive unit 100, the disclosed novel head 10, such as, but not limited to, one whose body member is constructed from corn starch or bamboo can slide or snap onto unit 100 at the base/first end of brush head 10.

In one replacement head 10 embodiment, the PLA material can be derived from cornstarch and can be combined with talcum to create the biodegradable brush head 10, excluding any bristles and metal rings/interior connectors.

The PLA material can be made from the sugars in corn starch. In one method for transforming corn into plastic for use as a material for brush head 10, corn kernels can be immersed in sulfur dioxide and hot water to cause its components to break down into starch, protein, and fiber. The kernels can then be ground and the corn oil can be separated from the starch. The starch can be composed of long chains of carbon molecules, similar to the carbon chains in plastic from fossil fuels. Some citric acids can be mixed in/included to form a long-chain polymer (a large molecule consisting of repeating smaller units) that can be used for the building block for plastic. The eco-friendly material(s) or bio-material(s) that can be used for manufacturing the replacement head 10 can include the following materials, either alone or in a combination of two or more materials: Rice Husk; Bamboo; BioPET (a mixture composed of plastic and sugar or PLA); Castor Bean Oil; Boar Bristle; Charcoal Bristles or Charcoal as a mixture to the base; any wood or paper mixture; Resin or Shellac or chicle (tree sap); Avocado; Agave Fiber; Bees Wax; PLA (from Sugar or Corn); Silicone; Paper; Metal; Cassava; Seaweed; Starch & Vegetable oil; Potato starch; Arboform (hemp, wax, flax and wood mixture); Hemp; Polyhydroxyalkanoates (PHA); Polylactic Acid (PLA); Polybutylene Succinate (PBS); Polycaprolactone (PCL) including Aliphatic Polyesters including poly-3-hydroxybutyrate (PHB), polyhydroxyvalerate (PHV), polyhydroxyhexanoate Polyanhydrides; Polyvinyl alcohol; Starch derivatives; Cellulose esters like cellulose acetate and nitrocellulose and their derivatives (celluloid); Polyethylene terephthalate; Cornstarch PLA; or Sugarcane PLA.

Thus, the replacement brush head 10 can be formed from a variety of bio-materials alone or in combination (i.e., two or more bio-materials). In some embodiments, the brush head 10 can be constructed from a combination of cornstarch PLA and sugarcane PLA.

In some embodiments, the replacement head 10 can be constructed from a biodegradable cornstarch material/component and can include SOFT BPA free durable nylon bristles.

Thus, preferably, the body member for brush head 10 can preferably be made from one or more materials that are biodegradable, BPA-free, nontoxic, plastic-free, recyclable, dye and color additive free, to provide the user with eco-friendly oral care.

Non-limiting examples of third-party electric toothbrushes that the disclosed biodegradable replacement head can be used with include, the PHILIPS SONICARE and ORAL B.

The novel brush head 10 can include one or more of the following non-limiting benefits and advantages:
(1) Can be made from clean non-toxic ingredients and natural materials;
(2) Can be made from 100% natural, biodegradable and compostable bamboo materials;
(3) Can be made from 100% natural ingredients;
(4) Can be made from 100% FSC certified biodegradable and compostable paper materials;
(5) Preferably does not contain artificial dyes, BPA, SLS, parabens and/or neurotoxins; and/or
(6) Can be FDA certified

Any measurements, values, amounts, temperatures, percentages, methods of making, mixing procedures, heating procedures, product shapes, product materials/ingredients, power/drive units, brush head connection mechanism, bristle movement mechanism, etc. disclosed herein are provided by way of example and not considered limiting, and other measurements, values, amounts, temperatures, percentages, methods of making, mixing procedures, heating procedures, product shapes, product materials/ingredients, power/drive units, brush head connection mechanism, bristle movement mechanism, etc. can be used and are considered within the scope of the disclosure. The brush head is not considered limited to the specific materials discussed herein and other biodegradable materials can be substituted and used, and all are considered within the scope of the disclosure. Furthermore, the amounts or range of amounts of any particular material is not considered limited to any amount described herein, and other amounts and ranges can also be used and considered within the scope of the disclosure.

It should be understood that the exemplary embodiments described herein should be considered in a descriptive sense only and not for purposes of limitation. Descriptions of features or aspects within each embodiment should typically be considered as available for other similar features or aspects in other embodiments. It will be understood by those of ordinary skill in the art that various changes in form, connection methods, bristle vibration mechanisms, shapes, biodegradable material(s) may be made therein without departing from their spirit and scope of the disclosure.

The above percentages for ingredients, materials, components, etc. in any of the compositions, can be considered to be by total weight, by total volume, by total mass, or by any other unit of measurement used or known for determining or stating the amounts of each ingredient, material, component, etc. contained in a particular composition.

While the novel biodegradable replacement toothbrush head has been described and disclosed in certain terms and has disclosed certain embodiments or modifications variations or alternatives, persons skilled in the art who have acquainted themselves with the disclosure, will appreciate that it is not necessarily limited by such terms, nor to the specific embodiments and modifications, variations or alternatives disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. An electric toothbrush system comprising,
a brush head comprising a neck and a head, the head including a plurality of bristles, wherein the brush head is composed of at least one biodegradable material; and
an electric drive unit configured to be connected to the brush head and configured to actuate the brush head.

2. The electric toothbrush system of claim 1, wherein the at least one biodegradable material is corn starch, dextrose, bamboo or a combination of about 60-80% polylactic acid and about 20-40% talcum.

3. The electric toothbrush system of claim 2 wherein the polylactic acid is derived from corn starch or dextrose.

4. The electric toothbrush system of claim 1 wherein the at least one biodegradable material is bamboo.

5. The electric toothbrush system of claim 1 further comprising a ring disposed within an internal passageway of the neck of the brush head at an opening for connecting the brush head to the electric drive unit.

6. The electric toothbrush system of claim 1 wherein the actuation is transmission of vibrational forces from the electric drive unit to the brush head.

7. The electric toothbrush system of claim 1 wherein the head of the brush head is circular or oval in shape.

8. The electric toothbrush system of claim 1 wherein the head and the neck are monolithically formed or constructed integral together to form a one-piece member.

9. The electric toothbrush system of claim 1 wherein the plurality of bristles are SOFT BPA free durable nylon bristles or bristles manufactured from castor bean oil.

10. The electric toothbrush system of claim 1, wherein the plurality of bristles extend from a bristle plate and the bristle plate is detachably disposed on the head of the brush head.

11. A biodegradable replacement head for an electric toothbrush, comprising:
a body member having a first end and a second end and defining an internal passageway, the body member having an opening at the first end for accessing the internal passageway, the body member adapted for removable connection to an electric power/drive unit of an electric toothbrush through receipt of a portion of the electric power/drive unit within the internal passageway, the body member constructed from one or more biodegradable materials; and
a plurality of bristles located near the second end of the body member.

12. The biodegradable replacement head of claim 11 wherein the one or more biodegradable materials is corn starch or dextrose.

13. The biodegradable replacement head of claim 11 wherein the one or more biodegradable materials is bamboo.

14. The biodegradable replacement head of claim 11 wherein the one or more biodegradable materials comprising about 60-80% polylactic acid; and about 20-40% talcum.

15. The biodegradable replacement head of claim 11 further comprising a ring disposed within the internal passageway at the opening of the first end for aiding in connection of the body member to the electric power/drive unit.

16. The biodegradable replacement head of claim 11 further comprising a bristle connection portion disposed at the second end of the body member.

17. The biodegradable replacement head of claim 14 wherein the polylactic acid is derived from corn starch.

18. A biodegradable replacement head for an electric toothbrush, comprising:
a body member having a first end and a second end and defining an internal passageway, the body member having an opening at the first end for accessing the internal passageway, the body member adapted for removable connection to an electric power/drive unit of an electric toothbrush through receipt of a portion of the electric power/drive unit within the internal passageway, the body member constructed from one or more biodegradable materials;
a bristle plate detachably disposed at the second end of the body member; and
plurality of bristles connected to the bristle plate and extending outward therefrom.

19. The biodegradable replacement head of claim 18, wherein the one or more biodegradable materials is corn starch, bamboo or a combination of about 60-80% polylactic acid and about 20-40% talcum.

20. A biodegradable replacement head for an electric toothbrush, comprising:
a body member having a first end and a second end and defining an internal passageway, the body member having an opening at the first end for accessing the internal passageway, the body member adapted for removable connection to an electric power/drive unit of an electric toothbrush through receipt of a portion of the electric power/drive unit within the internal passageway, the body member constructed from one or more biodegradable materials;
a bristle connection portion detachably disposed at the second end of the body member, the bristle connection portion being rounded in shape;
plurality of bristles connected to the bristle connection portion and extending outward therefrom; and
a base member disposed at the first end of the body member and having an internal passageway which is in communication with the internal passageway of the body member;
wherein the bristle connection portion and the body member monolithically formed or constructed integral together to form a one-piece member.
